(19) United States
(12) Patent Application Publication
(10) Pub. No.: US 2013/0140981 A1
(43) Pub. Date: Jun. 6, 2013

(54) LUMINESCENT SUBSTANCE AND LIGHT SOURCE HAVING SUCH A LUMINESCENT SUBSTANCE

(71) Applicants: Günter Huber, Schrobenhausen (DE); Barbara Huckenbeck, Augsburg (DE); Frank Jermann, Konigsbrunn (DE); Bianca Pohl, Gilching (DE)

(72) Inventors: Günter Huber, Schrobenhausen (DE); Barbara Huckenbeck, Augsburg (DE); Frank Jermann, Konigsbrunn (DE); Bianca Pohl, Gilching (DE)

(21) Appl. No.: 13/805,754

(22) PCT Filed: Jun. 7, 2011
(86) PCT No.: PCT/EP2011/059412

§ 371 Date: Dec. 20, 2012

(30) Foreign Application Priority Data
Jun. 24, 2010 (DE) 10 2010 030 473.5

(51) Int. Cl. C09K 11/77; H05B 33/12; H01J 1/63

(52) U.S. Cl. CPC C09K 11/7792; H01J 1/63; H05B 33/12; C09K 11/7734
USPC 313/503; 313/483; 252/301.4 F

(57) ABSTRACT

A blue to yellow emitting phosphor from the class of orthosilicates, which substantially has the structure EA2SiO4:D, wherein the phosphor comprises as component EA at least one of the elements EA=Sr, Ba, Ca or Mg alone or in combination, wherein the activating doping D consists of Eu and wherein a deficiency of SiO2 is introduced, such that a modified sub stoichiometric orthosilicate is present.

### TECHNICAL FIELD

The invention is based on a phosphor according to the preamble of claim 1 and a light source equipped with such a phosphor according to claim 8, in particular a conversion LED. Such conversion LEDs are suitable for general lighting, in particular.

### PRIOR ART

U.S. Pat. No. 7,489,073 discloses a conversion LED which uses a modified regular orthosilicate as phosphor.

Stable green phosphors, in particular having an emission maximum around 520-540 nm, are scarcely available. That makes it more difficult to use conversion LEDs in display backlighting and limits the optimization of high-CRI LEDs or warm-white LEDs. Hitherto, in products, orthosilicates have principally been used as green phosphors for this range. Although they have high quantum efficiencies, they exhibit an inadequate aging behavior in LEDS.

U.S. Pat. No. 7,489,073 discloses a nitride-orthosilicate having the composition AE₂₋ₓ₋ₐREₓEuₐSiO₄₋ₓNₓ (AE=Sr, Ba, Ca, Mg; RE=rare earths, in particular Y and/or La). EA or else AE here stands for alkaline earth metal elements. The incorporation of YN and/or LaN results in a

red shift in the spectral position and usually an improvement in the quantum efficiency of the phosphor. With the production method described therein, the LED aging method of said phosphor is already significantly better than in the case of the conventional orthosilicates or other green Sion phosphors such as e.g. Ba₃Si₆O₁₂N₂:Eu.

For many applications, such as e.g. for LCD backlighting, the stability in humid surroundings and at relatively high temperatures is still not optimal, however.

### SUMMARY OF THE INVENTION

The object of the present invention is to provide a phosphor according to the preamble of claim 1 which allows the properties of nitridic phosphors to be adapted to specific tests in a targeted manner.

This object is achieved by means of the characterizing features of claim 1.

Particularly advantageous configurations are found in the dependent claims.

According to the invention, a novel nitridic phosphor is now provided. This includes blue- or blue-green- to yellow-emitting phosphors which can be excited in particular in the emission range of typical UV and blue LEDs and at the same time have a very high stability in the LED. The phosphors can find applications in particular in LEDs with good color rendering, in LEDs for LCD backlighting, color-on-demand LEDs or white OLEDs.

White LEDs are increasingly gaining in importance in general lighting. In particular, there is a rising demand for warm-white LEDs having low color temperatures and good color rendering and at the same time high efficiency. Against the background of imminent prohibition of the general service incandescent lamp, which has low energy efficiency, alternative light sources having the best possible color rendering (CRI) are increasingly gaining in importance. Many consumers value luminous means having a light spectrum similar to an incandescent lamp.

The phosphors have to meet a series of requirements: a very high stability in relation to chemical influences, for example oxygen, moisture, interactions with potting materials, and in relation to radiation. In order to ensure a stable color locus as the system temperature rises, phosphors having a low temperature quenching behavior are additionally required.

Such phosphors are used in white LEDs and color-on-demand LEDs.

The excitation of such phosphors preferably takes place using short-wave radiation in the UV and short-wave blue, in particular in the range of 360 to 480 nm.

The invention is based on the provision of phosphors from the substance classes of the nitrido-orthosilicates.

It has been found that a deficiency of SiO₂ leads to higher quantum efficiencies. This results in a composition of the batch mixture for the stabilized nitrido-orthosilicate of AE₂₋ₓ₋ₐREₓEuₐSi_{1-y}O_{4-x-2y}Nₓ (AE=Sr, Ba, Ca, Mg; RE=rare earths, in particular Y and/or La), wherein x is preferably between 0.003 and 0.02, and a is preferably between 0.01 and 0.2. The factor Y crucial for the SiO₂ deficiency is in the range of between 0<y≦0.1, preferably in the range of 0.002≦y≦0.02. In the method described here for producing a stabilized nitrido-orthosilicate, in one embodiment the starting material side is additionally preferably extended by Si₃N₄ and La₂O₃ or Y₂O₃.

For the preparation of AE₂₋ₓ₋ₐREₓEuₐSi_{1-y}O_{4-x-2y}Nₓ either AECO₃, SiO₂ (La, Y)N and Eu₂O₃ or AECO₃, SiO₂, Si₃N₄, (La, Y)₂O₃ and Eu₂O₃ are required as starting substances. Furthermore, in particular fluorides and chlorides such AECl₂, AEF₂, and also NH₄Cl/NH₄F, H₃BO₃, LiF and cryolites, and combinations thereof, can be used as flux.

Essential features of the invention in the form of a numbered enumeration are:
1. A blue- to yellow-emitting phosphor from the class of orthosilicates, which substantially has the structure EA2SiO4:D, characterized in that the phosphor comprises as component EA=Sr, Ba, Ca or Mg alone or in combination, wherein the activating doping D consists of Eu and replaces a proportion of EA and wherein a deficiency of SiO₂ is introduced, such that a modified sub-stoichiometric orthosilicate is present.
2. The phosphor as claimed in claim 1, characterized in that the orthosilicate is an orthosilicate stabilized with RE and N, where RE=rare earth metal, such that the stoichiometry corresponds to EA₂₋ₓ₋ₐREₓEUₐSi1-yO_{4-x-2y}Nₓ.
3. The phosphor as claimed in claim 1, characterized in that RE=La or Y alone or in combination.
4. The phosphor as claimed in claim 2, characterized in that the proportion a of the Eu is between a=0.01 and 0.20.
5. The phosphor as claimed in claim 1, characterized in that EA contains Sr and/or Ba with at least 66 mol %, in particular with a Ca proportion of a maximum of 5 mol % and in particular with an Mg proportion of a maximum of 30 mol %.
6. The phosphor as claimed in claim 1, characterized in that the proportion x is between 0.003 and 0.02.
7. The phosphor as claimed in claim 1, characterized in that the factor y crucial for the deficiency is in the range of 0<y≦0.1, in particular between 0.002≦y≦0.02.
8. A light source comprising a primary radiation source, which emits radiation in the short-wave range of the optical spectral range in the wavelength range of 140 to 480 nm, wherein said radiation is converted wholly or partly into secondary radiation of longer wavelength in the visible spectral range by means of a first phosphor as claimed in any of the preceding claims.
9. The light source as claimed in claim 8, characterized in that a light-emitting diode on the basis of InGaN or InGaAlP or a low-pressure- or high-pressure-based discharge lamp, in particular comprising an indium-containing filling, or an electroluminescent lamp is used as the primary radiation source.
10. The light source as claimed in claim 8, characterized in that part of the primary radiation is furthermore converted into radiation of longer wavelength by means of further phosphors, wherein the phosphors are in particular suitably chosen and mixed to generate white light.
11. A method for producing a high-efficiency phosphor, characterized by the following method steps:
a) providing the starting substances SiO₂ alone or in combination with Si₃N₄ as Si component and at least one RE precursor selected from the group REN or RE2O3, and at least one EA precursor, preferably EACO3, in particular at least one precursor from the group SrCO₃, BaCO₃, CaCO₃ and MgO, and an EU precursor, in particular Eu2O3, wherein the Si component is provided in a sub-stoichiometric proportion;
b) mixing the starting substances and annealing for at least 1 hour under a reducing atmosphere at temperatures of 1000 to 1500° C.;
c) if appropriate subsequent second annealing of the phosphor produced in step b) at 800 to 1400° C.
12. The method as claimed in claim 11, characterized in that fluorides or chlorides, in particular at least one from the group EAF2, EAC12, RECl2 or REF2, or of ammonium, or of H3BO3, or LiF or cryolites alone or in combination are used as flux in step a) and/or in step c).
13. A conversion LED comprising a chip, which emits primary radiation, and comprising a phosphor-containing layer disposed in front of the chip, said layer converting at least part of the primary radiation of the chip into secondary radiation, wherein a phosphor as claimed in any of claims 1 to 7 is used.
14. The conversion LED as claimed in claim 13, characterized in that (Lu, Y, Gd)₃(Al, Ga)₅O₁₂:Ce is used as further phosphor for generating white.
15. The conversion LED as claimed in claim 13, characterized in that a Cu-modified CaAlSiN3:Eu is used as further phosphor.

### BRIEF DESCRIPTION OF THE DRAWINGS

The invention will be explained in greater detail below on the basis of a number of exemplary embodiments. In the figures:

FIG. 1 shows a conversion LED;

FIG. 2 shows an LED module with a phosphor mixture applied at a distance;

FIG. 3 shows an emission spectrum of an LCD backlight LED comprising a mixture of a green phosphor of the type (Sr,Ba,La)₂Si_{1-y}O_{4-x-2y}Nₓ:Eu²⁺ and a red phosphor of the type alumonitridosilicate CaAlSiN3:Eu²⁺.

FIG. 4 shows a comparison of the emission of an LED comprising the phosphor of the type (Sr, Ba, La)₂Si_{1-y}O_{4-x-2y}Nₓ: Eu²⁺ at different phosphor concentrations.

FIG. 5 shows a comparison of the change in the conversion rate (green/blue emission) per 1 h determined after a preceding LED operating duration of approximately 6 h at an ambient temperature of 45° C. and with 95% air humidity (LED mounted on printed circuit board with additional cooling; LED current density 500 mA/mm²).

### PREFERRED EMBODIMENTS OF THE INVENTION

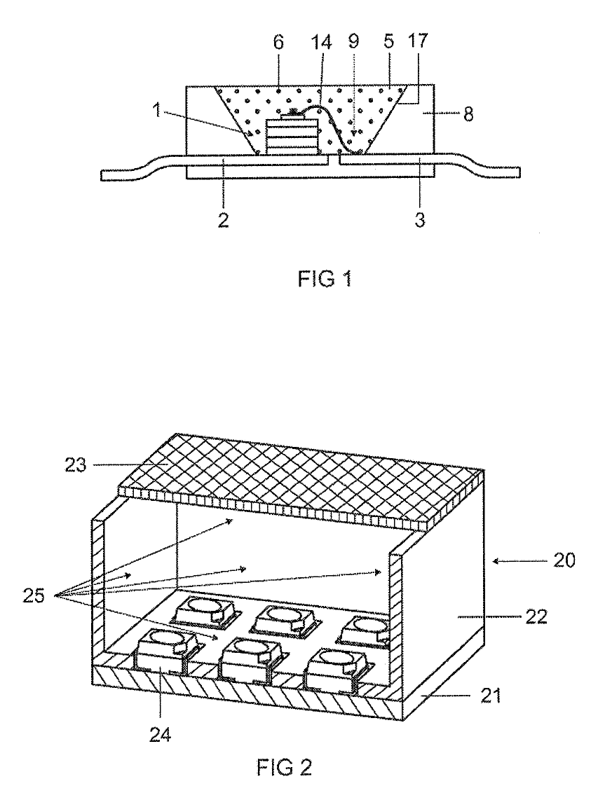

FIG. 1 shows the construction of a conversion LED for white light on the basis of RGB, as known per se. The light source is a semiconductor component comprising a blue-emitting chip 1 of the type InGaN having a peak emission wavelength of 435 to 455 nm peak wavelength, for example 455 nm, which is embedded into a light-opaque main housing 8 in the region of a cutout 9. The chip 1 is connected via a bonding wire 14 to a first connection 3 and directly to a second electrical connection 2. The cutout 9 is filled with a potting compound 5 containing a silicone (60-90% by weight) and phosphors 6

(approximately 15 to 40% by weight) as main constituents. A first phosphor is a green-emitting nitrido-orthosilicate phosphor AE₂₋ₓ₋ₐREₓEuₐSi_{1-y}O_{4-x-2y}Nₓ where AE is Ba and where RE is Y. Other exemplary embodiments use at least one of the following elements: for AE=Ba, Sr, Ca, Mg and for RE=La, Y. In addition, a red-emitting phosphor, for example an alumonitridosilicate or calsin, is used as second phosphor. The cutout has a wall 17 serving as a reflector for the primary and secondary radiation from the chip 1 and the phosphors 6, respectively. Concrete exemplary embodiments of further phosphors, for generating white, are (Lu,Y,Gd)₃(Al,Ga)₅O₁₂:Ce or else a Cu-modified CaAlSiN3:Eu.

In principle, it is possible to use the phosphor mixture as a dispersion, as a thin film, etc., directly on the LED or else, as known per se, on a separate carrier disposed in front of the LED.

FIG. 2 shows such a module 20 comprising diverse LEDs 24 on a baseplate 21. A housing having side walls 22 and a cover plate 12 is mounted thereabove. The phosphor mixture is applied here as a layer 25 both on the side walls and primarily on the cover plate 23, which is transparent.

Other suitable light sources are fluorescent lamps or high-pressure discharge lamps in which the novel phosphor can be used for converting the primary radiation, alone or in combination with other phosphors.

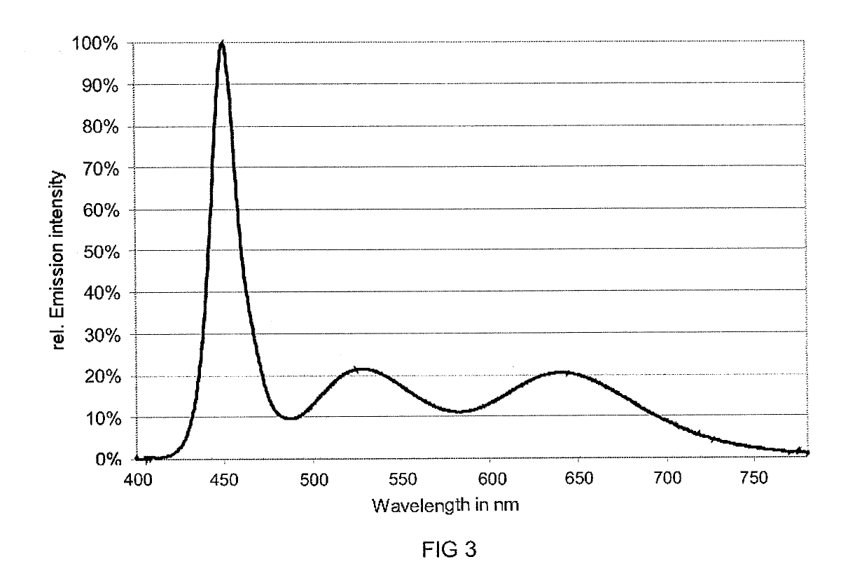

FIG. 3 shows the spectrum of an LCD backlight LED on the basis of two phosphors. The wavelength in nm is plotted on the abscissa, and the relative emission intensity is plotted on the ordinate. A first introduced phosphor is a red phosphor of the type CaAlSiN3:Eu, and the second phosphor is a green phosphor according to the invention having the batch stoichiometry (Ba, Sr)₂₋ₓ₋ₐLaₓEuₐSi_{1-y}O_{4-x-2y}Nₓ where x=0.005, a=0.08 and y=0.0075.

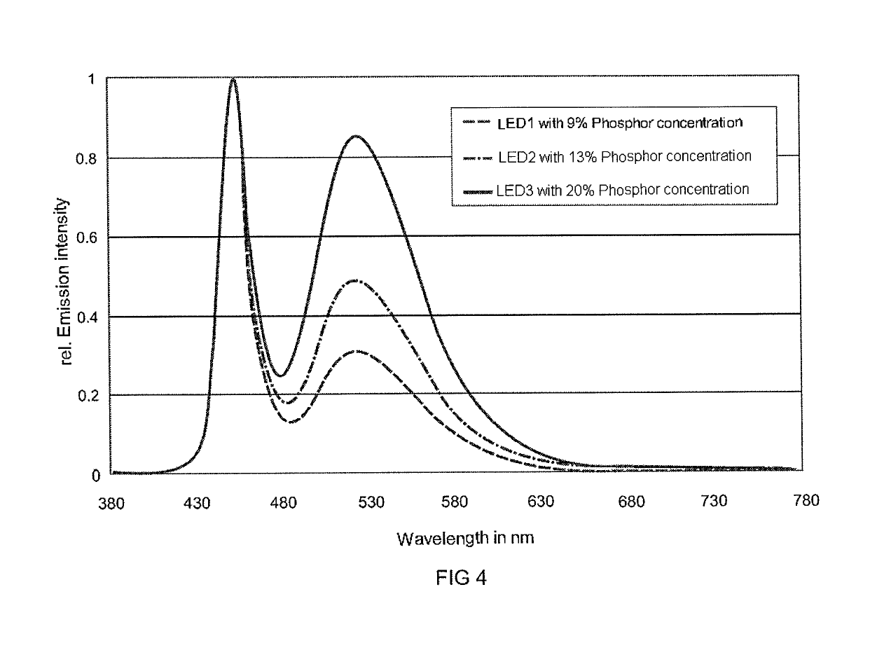

FIG. 4 shows a comparison of emission spectra of LEDs having introduced phosphor concentrations of 9, 13 and 20% by weight. The phosphor is a green phosphor according to the invention having the batch stoichiometry (Ba, Sr)₂₋ₓ₋ₐLaₓEuₐSi_{1-y}O_{4-x-2y}Nₓ where x=0.005, a=0.08 and y=0.0075. The wavelength in nm is plotted on the abscissa, and the relative emission intensity is plotted on the ordinate.

The novel sub-stoichiometric phosphor is produced in the following way:

The starting materials analogous to the batch mixtures 1 to 4, preferably together with a suitable flux, are weighed in and homogenized. Afterward, the starting material mixture is annealed for a number of hours under a reducing atmosphere (in particular under N₂ or Ar or a mixture of N₂/H₂ or Ar/H₂) at temperatures of between 1000° C. and 1500° C. This can be followed by a second annealing, likewise under a reducing atmosphere (in particular under N₂ or Ar or a mixture of N₂/H₂ or Ar/H₂) at temperatures of between 800° C. and 1400° C. The synthesis is carried out in a suitable furnace, such as e.g. tubular furnace or chamber furnace.

### a) Comparative Example/Batch Mixture 1 (Prior Art):

### 73.5 g SrCO₃, 98.1 g BaCO₃, 31.1 g SiO₂ and 7.2 g Eu₂O₃;

### b) Comparative Example/Batch Mixture 2 (Prior Art):

### 73.3 g SrCO₃, 97.9 g BaCO₃, 31.1 g SiO₂, 0.4 g LaN and 7.2 g Eu₂O₃;

### c) Exemplary Embodiment/Batch Mixture 3:

73.4 g SrCO₃, 98.0 g BaCO₃, 30.8 g SiO₂, 0.1 g Si₃N₄, 0.4 g La₂O₃ and 7.2 g Eu₂O₃;

### d) Exemplary Embodiment/Batch Mixture 4:

### 73.3 g SrCO₃, 98.0 g BaCO₃, 30.9 g SiO₂, 0.4 g LaN and 7.2 g Eu₂O₃;

Even as a result of the incorporation of lanthanum and nitrogen as in comparative example 2, a significant improvement in the LED stability can already be discerned at relatively high temperatures and in a humid environment. This stability is still not optimal, however, for many applications, such as e.g. for LCD backlighting.

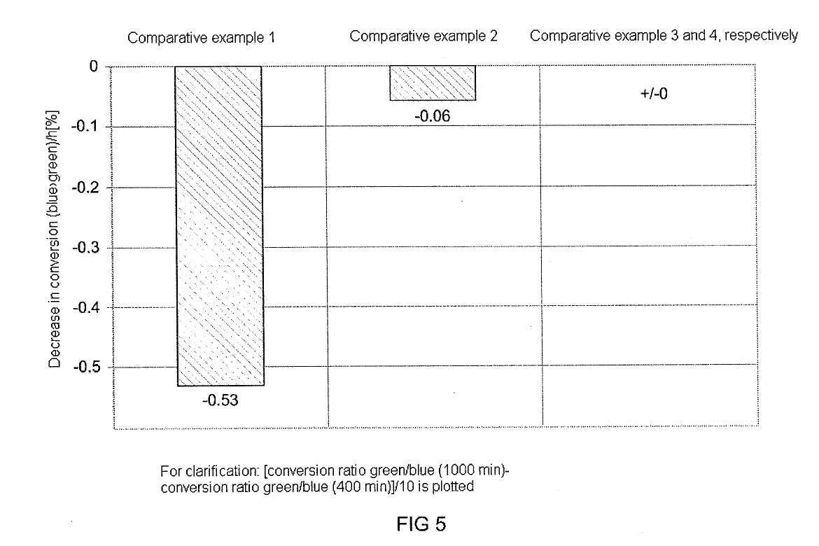

The new batch stoichiometry described here in accordance with exemplary embodiment 3 or 4, respectively, with a corresponding deficiency of SiO₂ demonstrably leads to an improved LED stability, primarily in a humid environment and at relatively high temperatures. FIG. 5 illustrates the LED stability at a temperature of 45° C. and with 95% air humidity for the four different batch mixtures. The relative conversion ratio is plotted as the

ordinate, and the abscissa is the time in minutes. It is evident that exemplary embodiments 3 and 4 are approximately equivalent to one another and both are appreciably superior to comparative examples 1 and 2.

The relative quantum efficiencies QE₄₆₀ of the novel phosphors in accordance with exemplary embodiments 3 and 4 upon excitation with 460 nm is 3% higher than in the case of comparative example 2.

The presented nitrido-orthosilicates of the form AE₂₋ₓ₋ₐREₓEUₐSi_{1-y}O₄₋ₓ₋₂Nₓ are typically prepared from ARCO₃, SiO₂, REN and Eu₂O₃ or AECO₃, SiO₂, Si₃N₄, (RE)₂O₃ and Eu₂O₃ as starting substances. In the latter, the rare earths are used as (RE)₂O₃ if trivalent oxides are preferably formed. In the case of rare earth oxides which are preferably present as mixed oxides as, for example, Tb is usually present as a III/IV mixed oxide Tb₄O₇, the mixed oxides are preferably used. Furthermore, instead of REN or RE oxide in conjunction with Si₃N₄, it is also possible to use In, Y or Sc as nitride or as a combination of oxide and Si₃N₄.

Furthermore, in particular fluorides and chlorides such as AECl₂ or RECl₂, AEF₂ or RECl₂ but also NH₄Cl/NH₄F, H₃BO₃, LiF and cryolites, and combinations thereof, can be used as flux.

The starting materials analogous to the batch mixtures 1 to 15, preferably together with a suitable flux, are weighed in and homogenized. Afterward, the starting material mixture is annealed for a number of hours under a reducing atmosphere (in particular under N₂ or Ar or a mixture of N₂/H₂ or Ar/H₂)

at temperatures of between 1000° C. and 1500° C. This can be followed by a second annealing, likewise under a reducing atmosphere (for example under N₂ or Ar or a mixture of N₂/H₂ or Ar/H₂) at temperatures of between 800° C. and 1400° C. The synthesis is carried out in a suitable furnace, such as e.g. tubular furnace or chamber furnace.

### Batch Mixture 1:

### 69.9 g SrCO₃, 93.3 g BaCO₃, 29.3 g SiO₂, 0.1 g Si₃N₄, 0.5 g La₂O₃ and 7.0 g Eu₂O₃

### Batch Mixture 2:

### 69.9 g SrCO₃, 93.3 g BaCO₃, 29.3 g SiO₂, 0.1 g Si₃N₄, 0.4 g Pr₆O₁₁ and 7.0 g Eu₂O₃

### Batch Mixture 3:

### 69.9 g SrCO₃, 93.3 g BaCO₃, 29.3 g SiO₂, 0.1 g Si₃N₄, 0.4 g Nd₂O₃ and 7.0 g Eu₂O₃

### Batch Mixture 4:

### 69.9 g SrCO₃, 93.3 g BaCO₃, 29.3 g SiO₂, 0.1 g Si₃N₄, 0.4 g Sm₂O₃ and 7.0 g Eu₂O₃

### Batch Mixture 5:

### 69.9 g SrCO₃, 93.3 g BaCO₃, 29.3 g SiO₂, 0.1 g Si₃N₄, 0.4 g Gd₂O₃ and 7.0 g Eu₂O₃

Batch mixture 6:

### 69.9 g SrCO₃, 93.3 g BaCO₃, 29.3 g SiO₂, 0.1 g Si₃N₄, 0.5 g Tb₄O₇ and 7.0 g Eu₂O₃

### Batch Mixture 7:

### 69.9 g SrCO₃, 93.3 g BaCO₃, 29.3 g SiO₂, 0.1 g Si₃N₄, 0.5 g Dy₂O₃ and 7.0 g Eu₂O₃

### Batch Mixture 8:

### 69.9 g SrCO₃, 93.3 g BaCO₃, 29.3 g SiO₂, 0.1 g Si₃N₄, 0.5 g Ho₂O₃ and 7.0 g Eu₂O₃

### Batch Mixture 9:

### 69.9 g SrCO₃, 93.3 g BaCO₃, 29.3 g SiO₂, 0.1 g Si₃N₄, 0.5 g Er₂O₃ and 7.0 g Eu₂O₃

### Batch Mixture 10:

### 69.9 g SrCO₃, 93.3 g BaCO₃, 29.3 g SiO₂, 0.1 g Si₃N₄, 0.5 g Tm₂O₃ and 7.0 g Eu₂O₃

### Batch Mixture 11:

### 69.9 g SrCO₃, 93.3 g BaCO₃, 29.3 g SiO₂, 0.1 g Si₃N₄, 0.5 g Yb₂O₃ and 7.0 g Eu₂O₃

### Batch Mixture 12:

### 69.9 g SrCO₃, 93.3 g BaCO₃, 29.3 g SiO₂, 0.1 g Si₃N₄, 0.5 g Lu₂O₃ and 7.0 g Eu₂O₃

### Batch Mixture 13:

### 69.9 g SrCO₃, 93.3 g BaCO₃, 29.3 g SiO₂, 0.1 g Si₃N₄, 0.4 g Y₂O₃ and 7.0 g Eu₂O₃

### Batch Mixture 14:

### 69.9 g SrCO₃, 93.3 g BaCO₃, 29.3 g SiO₂, 0.1 g Si₃N₄, 0.2 g Sc₂O₃ and 7.0 g Eu₂O₃

### Batch Mixture 15:

### 69.9 g SrCO₃, 93.3 g BaCO₃, 29.3 g SiO₂, 0.1 g Si₃N₄, 0.4 g In₂O₃ and 7.0 g Eu₂O₃

Table 1 below reproduces a comparison of the spectral properties on the basis of the example of an La/N doping with and without SiO₂ deficiency.

TABLE 1

| | | | | | FWHM | |
|---|---|---|---|---|---|---|
| Composition | λ_{exc}. [nm] | x | y | λ_{dom} [nm] | [nm] | QE [%] |
| (Ba_{0.9575}Sr_{0.9575}La_{0.005}Eu_{0.08})SiO_{3.995}N_{0.005} | 460 | 0.285 | 0.638 | 545.9 | 64.2 | 87 |
| (Ba_{0.9575}Sr_{0.9575}La_{0.005}Eu_{0.08})v | 460 | 0.285 | 0.639 | 545.9 | 64.1 | 100 |

The spectral data of further exemplary embodiments are presented in Table 2 below.

TABLE 2

| | | | | | FWHM | |
|---|---|---|---|---|---|---|
| Composition | λ_{exc}. [nm] | x | y | λ_{dom} [nm] | [nm] | QE [%] |
| (Ba_{0.9575}Sr_{0.9575}La_{0.005}Eu_{0.08})Si_{0.9925}O_{3.9875}N_{0.005} | 460 | 0.285 | 0.639 | 545.9 | 64.1 | 1.00 |
| Ba_{0.9575}Sr_{0.9575}Pr_{0.005}Eu_{0.08})Si_{0.9925}O_{3.9875}N_{0.005} | 460 | 0.288 | 0.636 | 546.4 | 64.4 | 0.95 |
| Ba_{0.9575}Sr_{0.9575}Sm_{0.005}Eu_{0.08})Si_{0.9925}O_{3.9875}N_{0.005} | 460 | 0.285 | 0.638 | 545.9 | 65.0 | 0.89 |
| Ba_{0.9575}Sr_{0.9575}Gd_{0.005}Eu_{0.08})Si_{0.9925}O_{3.9875}N_{0.005} | 460 | 0.286 | 0.637 | 546.1 | 65.4 | 0.97 |
| Ba_{0.9575}Sr_{0.9575}Tb_{0.005}Eu_{0.08})Si_{0.9925}O_{3.9875}N_{0.005} | 460 | 0.290 | 0.637 | 546.9 | 65.2 | 1.02 |
| Ba_{0.9575}Sr_{0.9575}Dy_{0.005}Eu_{0.08})Si_{0.9925}O_{3.9875}N_{0.005} | 460 | 0.289 | 0.637 | 546.7 | 65.1 | 1.00 |
| Ba_{0.9575}Sr_{0.9575}Ho_{0.005}Eu_{0.08})Si_{0.9925}O_{3.9875}N_{0.005} | 460 | 0.292 | 0.635 | 547.2 | 65.7 | 0.98 |
| Ba_{0.9575}Sr_{0.9575}Er_{0.005}Eu_{0.08})Si_{0.9925}O_{3.9875}N_{0.005} | 460 | 0.297 | 0.632 | 548.1 | 66.5 | 0.97 |
| Ba_{0.9575}Sr_{0.9575}Tm_{0.005}Eu_{0.08})Si_{0.9925}O_{3.9875}N_{0.005} | 460 | 0.297 | 0.634 | 548.2 | 66.4 | 1.00 |
| Ba_{0.9575}Sr_{0.9575}Yb_{0.005}Eu_{0.08})Si_{0.9925}O_{3.9875}N_{0.005} | 460 | 0.298 | 0.633 | 548.3 | 67.1 | 0.98 |
| Ba_{0.9575}Sr_{0.9575}Lu_{0.005}Eu_{0.08})Si_{0.9925}O_{3.9875}N_{0.005} | 460 | 0.298 | 0.632 | 548.3 | 67.2 | 1.01 |
| Ba_{0.9575}Sr_{0.9575}Y_{0.005}Eu_{0.08})Si_{0.9925}O_{3.9875}N_{0.005} | 460 | 0.294 | 0.635 | 547.6 | 65.5 | 1.02 |
| Ba_{0.9575}Sr_{0.9575}In_{0.005}Eu_{0.08})Si_{0.9925}O_{3.9875}N_{0.005} | 460 | 0.301 | 0.630 | 548.8 | 68.0 | 0.99 |
| Ba_{0.9575}Sr_{0.9575}Sc_{0.005}Eu_{0.08})Si_{0.9925}O_{3.9875}N_{0.005} | 460 | 0.296 | 0.633 | 548.0 | 66.9 | 1.00 |

1. A blue to yellow emitting phosphor from the class of orthosilicates, which substantially has the structure EA2SiO4:D, wherein the phosphor comprises as component EA at least one of the elements EA=Sr, Ba, Ca or Mg alone or in combination, wherein the activating doping D consists of Eu and wherein a deficiency of SiO2 is introduced, such that a modified sub stoichiometric orthosilicate is present.

2. The phosphor as claimed in claim 1, wherein the orthosilicate is an orthosilicate stabilized with SE and N, where SE=rare earth metal, such that the stoichiometry corresponds to EA2 x aSExEUaSi1 yO4 x 2yNx.

3. The phosphor as claimed in claim 1, wherein SE=La or Y alone or in combination.

4. The phosphor as claimed in claim 2, wherein the proportion a of the Eu is between a=0.01 and 0.20.

5. The phosphor as claimed in claim 1, wherein EA contains Sr and/or Ba with at least 66 mol %, in particular with a Ca proportion of a maximum of 5 mol % and in particular with an Mg proportion of a maximum of 30 mol %.

6. The phosphor as claimed in claim 1, wherein the proportion x is between 0.003 and 0.02.

7. The phosphor as claimed in claim 1, wherein the factor y crucial for the deficiency is in the range of 0<y≦0.1, in particular between 0.002≦y≦0.02.

8. A light source comprising a primary radiation source, which emits radiation in the short wave range of the optical spectral range in the wavelength range of 140 to 480 nm, wherein said radiation is converted wholly or partly into secondary radiation of longer wavelength in the visible spectral range by means of a first phosphor as claimed in claim 1.

9. The light source as claimed in claim 8, wherein a light-emitting diode on the basis of InGaN or InGaAlP or a low pressure or high pressure based discharge lamp, in particular comprising an indium containing filling, or an electroluminescent lamp is used as the primary radiation source.

10. The light source as claimed in claim 8, wherein part of the primary radiation is furthermore converted into radiation of longer wavelength by means of further phosphors, wherein the phosphors are in particular suitably chosen and mixed to generate white light.

11. A method for producing a high efficiency phosphor, comprising the steps of:
a) providing the starting substances SiO2 alone or in combination with Si3N4 as Si component and at least one SE precursor selected from the group SEN or SE2O3, and at least one EA precursor, preferably EAC03, in particular at least one precursor from the group SrCO3, BaCO3, CaCO3 and MgO, and an EU precursor, in particular Eu2O3, wherein the Si component is provided in a sub-stoichiometric proportion;
b) mixing the starting substances and annealing for at least 1 hour under a reducing atmosphere at temperatures of 1000 to 1500° C.;
c) if appropriate subsequent second annealing of the phosphor produced in step b) at 800 to 1400° C.

12. The method as claimed in claim 11, wherein fluorides or chlorides, in particular at least one from the group EAF2, EAC12, RECl2 or REF2, or of ammonium, or of H3BO3, or LiF or cryolites alone or in combination are used as flux in step a) and/or in step c).

13. A conversion LED comprising a chip, which emits primary radiation, and comprising a phosphor containing layer disposed in front of the chip, said layer converting at least part of the primary radiation of the chip into secondary radiation, wherein a phosphor as claimed in claim 1 is used.

14. The conversion LED as claimed in claim 13, wherein (Lu, Y, Gd)3(Al, Ga)5O12:Ce is used as further phosphor for generating white.

15. The conversion LED as claimed in claim 13, wherein a Cu modified CaAlSiN3:Eu is used as further phosphor.
